(19) United States
(12) Patent Application Publication
(10) Pub. No.: US 2014/0211393 A1
(43) Pub. Date: Jul. 31, 2014

(54) DETACHABLE ROTARY EXTENDED KEYBOARD PLATE

(71) Applicant: Bing-Zhang LEE, Taipei City (TW)

(72) Inventor: Bing-Zhang LEE, Taipei City (TW)

(21) Appl. No.: 14/167,465

(22) Filed: Jan. 29, 2014

(30) Foreign Application Priority Data
Jan. 30, 2013 (TW) 102202049
Nov. 4, 2013 (TW) 102140010

(51) Int. Cl. G06F 1/16

(52) U.S. Cl. CPC G06F 1/1615
USPC 361/679.12

(57) ABSTRACT

The present invention provides a detachable rotary extended keyboard plate, which includes a sleeve member, and the sleeve member includes: a bottom plate having one end formed with an engaging sheet, after the engaging sheet is rotated, the additional space formed on the bottom plate allows a portable electronic device to stand in a multi-angle manner; a support sheet; a combination sheet; at least a first fasten device disposed on the engaging sheet or the combination sheet; and at least a second fasten device disposed on the keyboard and corresponding to the location where the first fasten device is disposed, the second fasten device is able to be combined with the first fasten device for enabling the keyboard to be fastened on the engaging sheet.

### BACKGROUND OF THE INVENTION

1. Field of the Invention

The present invention relates to a detachable rotary extended keyboard plate, especially to a detachable rotary extended keyboard plate allowing a wired or wireless keyboard to be disposed and enabling the wired or wireless keyboard to be rotated and allowing the keyboard to be stored and the operation distance of the keyboard to be adjustable and enabling a portable electronic device to stand in a multi-angle manner.

2. Description of Related Art

The Apple Inc. launched the tablet computer iPad at 2010, because the iPad is provided with advantages of being equipped with a touch control interface, lighter in weight, easier to be carried around and longer battery life comparing to a conventional notebook computer, the iPad becomes one of the most wanted electronic products in the market. For easily carrying or protecting the tablet computer, the user often buys a protecting sleeve for covering the tablet computer, thereby achieving the objectives of easy to carry around and protecting the tablet computer.

Referring to FIG. 1, which is a perspective view illustrating a conventional keyboard protecting sleeve of a tablet computer being assembled with a keyboard and a tablet computer. FIG. 1 discloses the design of a keyboard protecting sleeve used in a tablet computer, in which a bottom plate 500 is integrated at the left side of a keyboard 550; and for enabling a tablet computer 600 to stand, a space formed at the right side of the bottom plate 500 where the keyboard is not disposed is used for allowing the tablet computer 600 to stand thereon.

However, the space (the left side) of the bottom plate 500 where the keyboard 550 is disposed could not be used for allowing the tablet computer 600 to stand, so when a supporter 520 is utilized for adjusting the screen angle of the tablet computer 600, the available angles for adjustment is greatly limited, and the convenience in use could not be provided; meanwhile, for reserving a space on the bottom plate 500 to allow the tablet computer 600 to be disposed, the width occupied by the keyboard 550 has to be restrained, so the keys of the keyboard have to be coordinately smaller, and the user may find typing the keyboard is not as comfortable as he expects.

Accordingly, inventing a detachable rotary extended keyboard plate for effectively improving the above-mentioned disadvantages is necessary.

### SUMMARY OF THE INVENTION

One primary objective of the present invention is to provide a detachable rotary extended keyboard plate, in which an engaging sheet is provided for allowing a keyboard to be disposed thereon, and the keyboard is able to be rotated for being disposed on or released from the engaging sheet, thereby allowing the keyboard to be stored and the operation distance of the keyboard to be adjusted.

For achieving said objective, the present invention provides a detachable rotary extended keyboard plate, which includes a sleeve member, and the sleeve member includes: a bottom plate having one end formed with an engaging sheet allowing a keyboard to be disposed thereon; a support sheet formed at one side of the bottom plate and combined with a portable electronic device or a protective case of the portable electronic device, thereby enabling the portable electronic device to stand on the bottom plate; a combination sheet formed through being inwardly bent at another side of the bottom plate but not limited to be integrally extended from the bottom plate, the combination sheet is also able to be fastened at one side of the bottom plate with an adhering manner; at least a first fasten device disposed on the engaging sheet or the combination sheet; and at least a second fasten device disposed on the keyboard and corresponding to the location where the first fasten device is disposed, the second fasten device is able to be combined with the first fasten device for enabling the keyboard to be fastened on the engaging sheet.

For achieving said objective, the present invention provides a detachable rotary extended keyboard plate, which includes a sleeve member, and the sleeve member includes: a bottom plate formed with an engaging sheet allowing a keyboard to be disposed thereon; a support sheet formed at one side of the bottom plate and combined with a portable electronic device or a protective case of the portable electronic device, thereby enabling the portable electronic device to stand on the bottom plate; a combination sheet having one end combined with the keyboard; at least a first fasten device disposed on the engaging sheet; and at least a second fasten device disposed on the combination sheet and corresponding to the location where the first fasten device is disposed, the second fasten device is able to be combined with the first fasten device for enabling the keyboard to be fastened on the bottom plate.

For achieving said objective, the present invention provides a detachable rotary extended keyboard plate, which includes a sleeve member, and the sleeve member includes: a bottom plate formed with an engaging sheet allowing a keyboard to be disposed thereon; a support sheet formed at one side of the bottom plate and combined with a portable electronic device or a protective case of the portable electronic device, thereby enabling the portable electronic device to stand on the bottom plate; a combination sheet having one end combined with the keyboard; at least a first fasten device disposed on the engaging sheet; and at least a second fasten device disposed on the combination sheet and corresponding to the location where the first fasten device is disposed, the second fasten device is able to be combined with the first fasten device for enabling the keyboard to be fastened on the bottom plate.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view illustrating a conventional keyboard protecting sleeve of a tablet computer being assembled with a keyboard and a tablet computer;

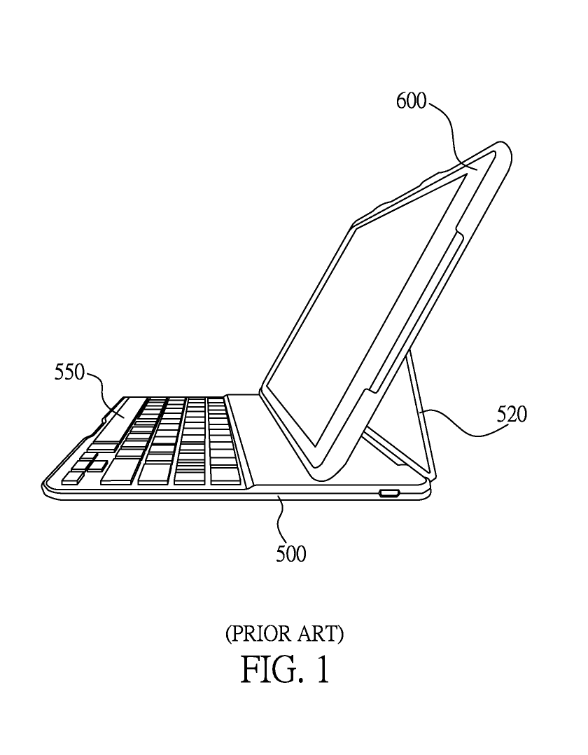

FIG. 2 is an exploded view illustrating the detachable rotary extended keyboard plate according to a preferred embodiment of the present invention;

FIG. 3 is a cross sectional view illustrating the assembly of the detachable rotary extended keyboard plate according to a preferred embodiment of the present invention;

FIG. 4 is a schematic view illustrating the assembly of the detachable rotary extended keyboard plate, a keyboard and a portable electronic device according to a preferred embodiment of the present invention;

FIG. 5 is a schematic view illustrating the assembly of the detachable rotary extended keyboard plate, the keyboard and the portable electronic device being unfolded according to a preferred embodiment of the present invention;

FIG. 6 is an exploded view illustrating the detachable rotary extended keyboard plate according to another preferred embodiment of the present invention;

FIG. 7 is an exploded view illustrating the detachable rotary extended keyboard plate according to one another preferred embodiment of the present invention;

FIG. 8 is a cross sectional view illustrating the assembly of the detachable rotary extended keyboard plate according to one another preferred embodiment of the present invention;

FIG. 9 is a schematic view illustrating the combination sheet being able to be fastened on the keyboard according to one another preferred embodiment of the present invention;

FIG. 10 is an exploded view illustrating the detachable rotary extended keyboard plate according to still one another preferred embodiment of the present invention;

FIG. 11a is a cross sectional view illustrating the assembly of the detachable rotary extended keyboard plate wherein one distal end of the combination sheet being formed with a bending according to still one another preferred embodiment of the present invention;

FIG. 11b is a cross sectional view illustrating the assembly of the detachable rotary extended keyboard plate wherein one distal end of the combination sheet not being formed with a bending according to still one another preferred embodiment of the present invention;

FIG. 12 is an exploded view illustrating the detachable rotary extended keyboard plate according to still one another preferred embodiment of the present invention; and

FIG. 13 is a schematic view illustrating the assembly of the detachable rotary extended keyboard plate and a portable electronic device according to still one another preferred embodiment of the present invention.

### DETAILED DESCRIPTION OF THE PREFERRED EMBODIMENT

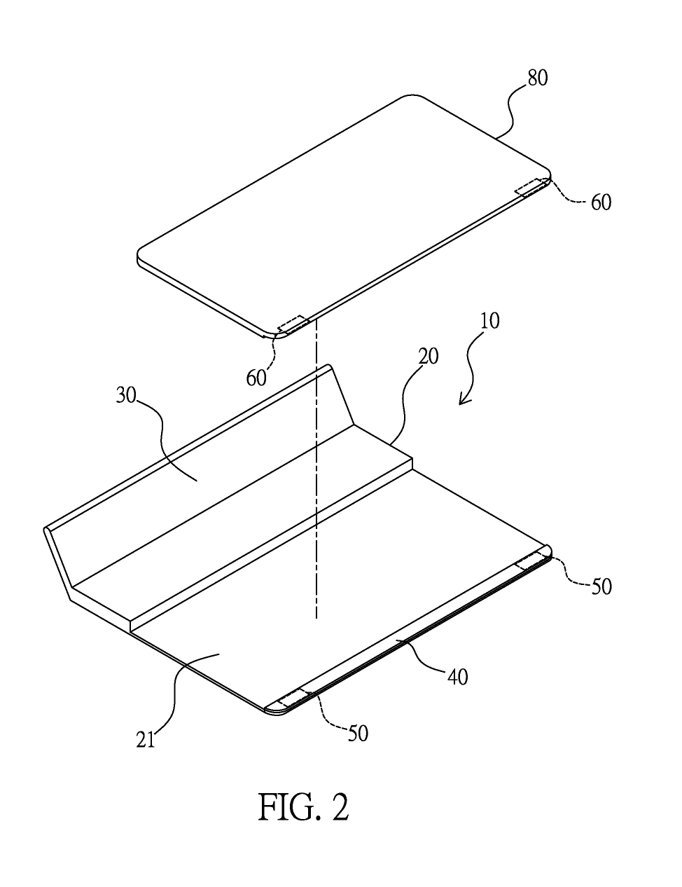

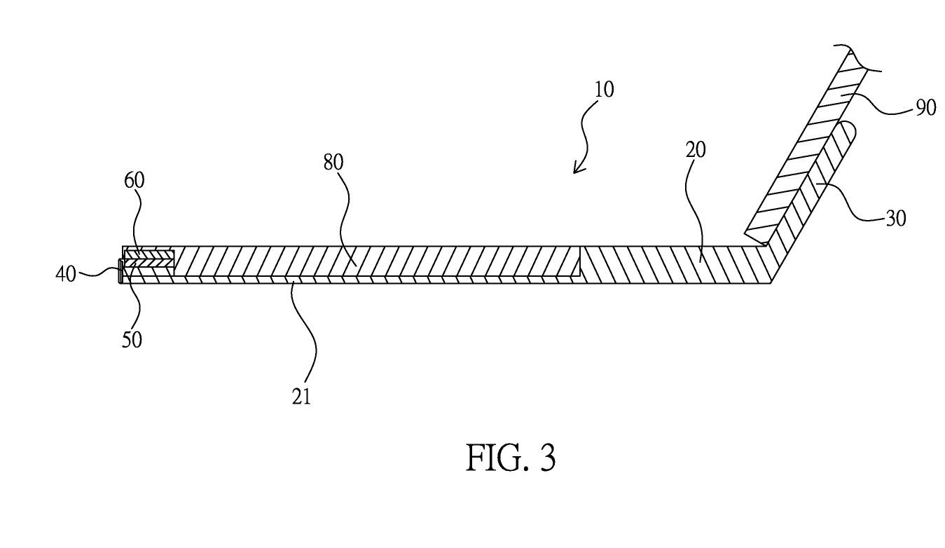

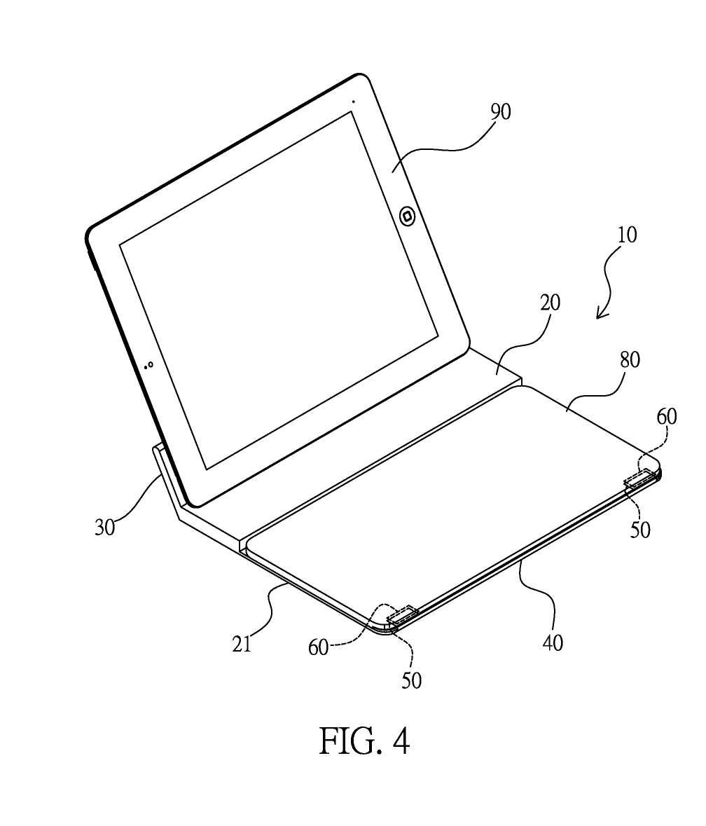

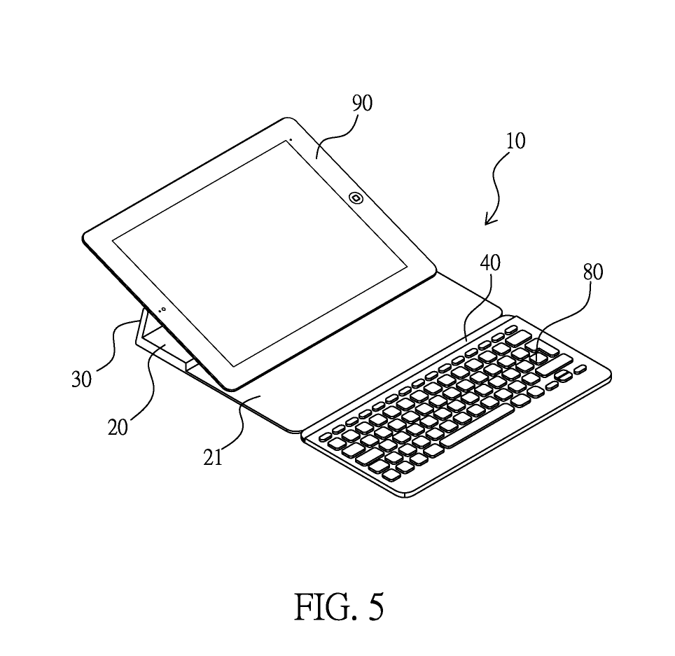

Referring from FIG. 2 to FIG. 5, wherein FIG. 2 is an exploded view illustrating the detachable rotary extended keyboard plate according to a preferred embodiment of the present invention; FIG. 3 is a cross sectional view illustrating the assembly of the detachable rotary extended keyboard plate according to a preferred embodiment of the present invention; FIG. 4 is a schematic view illustrating the assembly of the detachable rotary extended keyboard plate, a keyboard and a portable electronic device according to a preferred embodiment of the present invention; and FIG. 5 is a schematic view illustrating the assembly of the detachable rotary extended keyboard plate, the keyboard and the portable electronic device being unfolded according to a preferred embodiment of the present invention

As shown in figures, the detachable rotary extended keyboard plate includes a sleeve member 10. The sleeve member 10 includes a bottom plate 20, a support sheet 30, a combination sheet 40, at least a first fasten device 50 and at least a second fasten device 60.

The sleeve member 10 is e.g. but not limited to be made of leather, foamed sponge or polyurethane; according to this embodiment, polyurethane is adopted for being integrally formed as the sleeve member 10.

One end of the bottom plate 20 is formed with an engaging sheet 21 allowing a keyboard 80 to be disposed thereon, wherein the thickness defined by the engaging sheet 21 and the keyboard 80 is approximately the same as the thickness of the bottom plate 20, thereby preventing the keyboard 80 from protruding higher than the bottom plate 20 after being assembled. Wherein, the bottom plate 20 is e.g. but not limited to a thick paper board, a plastic plate or a glass fiber/carbon fiber plate; the keyboard 80 is e.g. but not limited to a wired keyboard or a wireless keyboard, when a wired keyboard is adopted, the wired keyboard can be connected to a portable electronic device 90 with a wire embedding manner, when a wireless keyboard is adopted, the wireless keyboard can be connected to the portable electronic device 90 through Bluetooth or other wireless communicating manners, thereby allowing a user to control the portable electronic device 90 or input texts or numbers to the portable electronic device 90. Wherein, the portable electronic device 90 is e.g. but not limited to a tablet computer.

The support sheet 30 is formed at one side of the bottom plate 20, e.g. but not limited to the right side, and is combined with the portable electronic device 90 or a protective case of the portable electronic device 90, thereby enabling the portable electronic device 90 to stand on the bottom plate 20. The user can rotate for adjusting the included angle defined between the support sheet 30 and the bottom plate 20 according to the actual needs so as to change the standing angle of the portable electronic device 90.

The combination sheet 40 is formed through being inwardly bent at another side of the bottom plate 20, e.g. but not limited to the left side, and the combination sheet 40 is not limited to be formed as being integrally extended from the bottom plate 20, the combination sheet 40 can be fastened at one side of the bottom plate 20 with an adhering manner. Wherein, the material of the combination sheet 40 is e.g. but not limited to a flexible material, and dispose at a bottom side at another end of the keyboard 80, and the bent portion of the combination sheet 40 is relatively thinner thereby being easily to be bent.

The at least one first fasten device 50 is disposed on the engaging sheet 21 or the combination sheet 40. According to this embodiment, the quantity of the at least one first fasten device 50 is two, and the two first fasten devices 50 are respectively disposed on the engaging sheet 21 and the combination sheet 40, however the above-mentioned arrangement is served as an example for fully disclosing the present invention and shall not be the limitation to the scope of the present invention. Wherein, the first fasten device 50 is e.g. but not limited to a Velcro fastener, a buckle member, a magnetic member or a tenon; according to the present invention, a magnetic member is adopted for illustration and shall not be the limitation to the scope of the present invention.

The at least one second fasten device 60 is disposed on the keyboard 80 and corresponding to the location where the first fasten device 50 is disposed, the second fasten device 60 is able to be combined with the first fasten device 50, thereby enabling the keyboard 80 to be fastened on the engaging sheet 21. According to this embodiment, the quantity of the at least one second fasten device 60 is two, and the two second fasten devices 60 are respectively disposed at the right side and the left side of the keyboard 80, however the above-mentioned arrangement is served as an example for fully disclosing the present invention and shall not be the limitation to the scope of the present invention. Wherein, the second fasten device 60 is e.g. but not limited to a Velcro fastener, a buckle member, a magnetic member or a tenon; according to the present invention, a magnetic member having opposite magnetism relative to the first fasten device 50 is adopted for illustration and shall not be the limitation to the scope of the present invention. In addition, the combination sheet 40 disposed on the engaging sheet 21 can also be disposed on the keyboard 80, and the same effect can still be provided.

As shown in FIG. 4, when being assembled, the first fasten devices 50 and the second fasten devices 60 can be utilized for fastening the keyboard 80 on the engaging sheet 21 with the keyboard 80 facing downwardly, then the support sheet 30 is combined with the portable electronic device 90 or a protective case of the portable electronic device 90, wherein the above two can be combined through a Velcro fastener, magnetic members or a tenon, so the bottom of the portable electronic device 90 is enabled to stand and be fastened on the bottom plate 20, what shall be addressed is that the combining manner is not the main characteristic of the present invention, therefore no further illustration is provided.

As shown in FIG. 5, when in use, the user outwardly rotates the keyboard 80, the flexible combination sheet 40 is outwardly rotated, so the keys of the keyboard 80 are allowed to face upwardly, and the first fasten devices 50 and the second fasten devices 60 are utilized for fastening the keyboard 80 on the combination sheet 40, thereby allowing the user to control the portable electronic device 90 or input texts or numbers to the portable electronic device 90 through the keyboard 80. As such, the detachable rotary extended keyboard plate provided by the present invention is novel and more practical in use comparing to the conventional keyboard protecting sleeve used in a portable device.

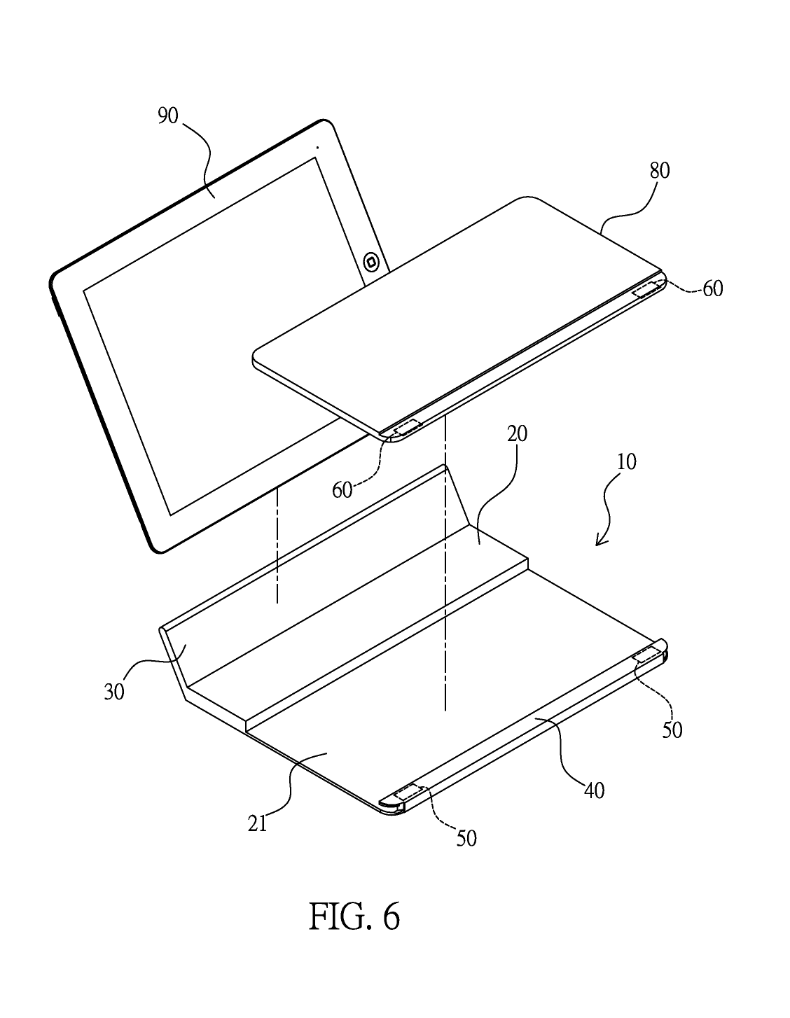

Referring to FIG. 6, which is an exploded view illustrating the detachable rotary extended keyboard plate according to another preferred embodiment of the present invention.

As shown in FIG. 6, according to the detachable rotary extended keyboard plate disclosed in another preferred embodiment of the present invention, the combination sheet 40 is made of a flexible material and covered at the other end of the keyboard 80; when being rotated, the first fasten devices 50 and the second fasten devices 60 drive the flexible combination sheet 40 to be outwardly rotated, and the keys of the keyboard 80 are allowed to face upwardly, thereby allowing the user to control the portable electronic device 90 or input texts or numbers to the portable electronic device 90 through the keyboard 80.

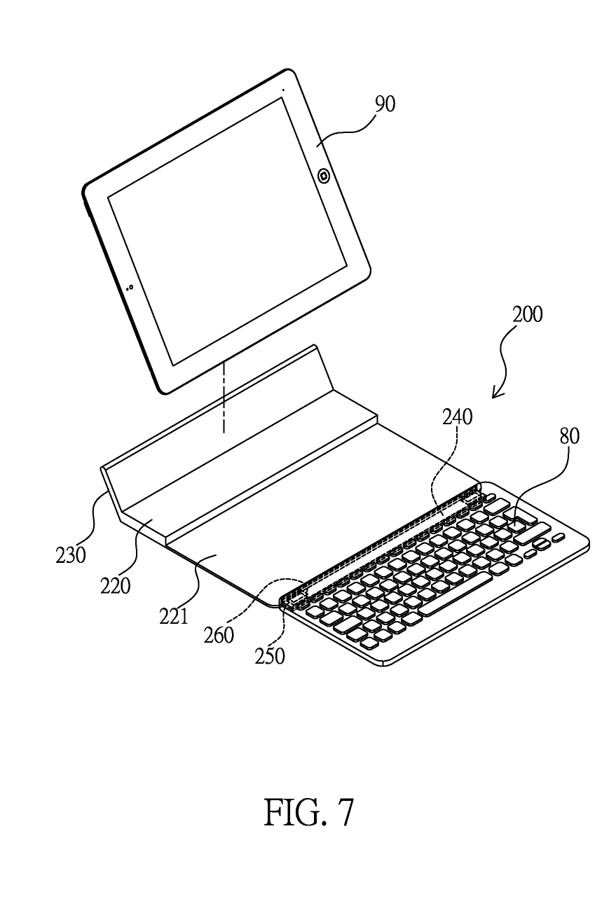

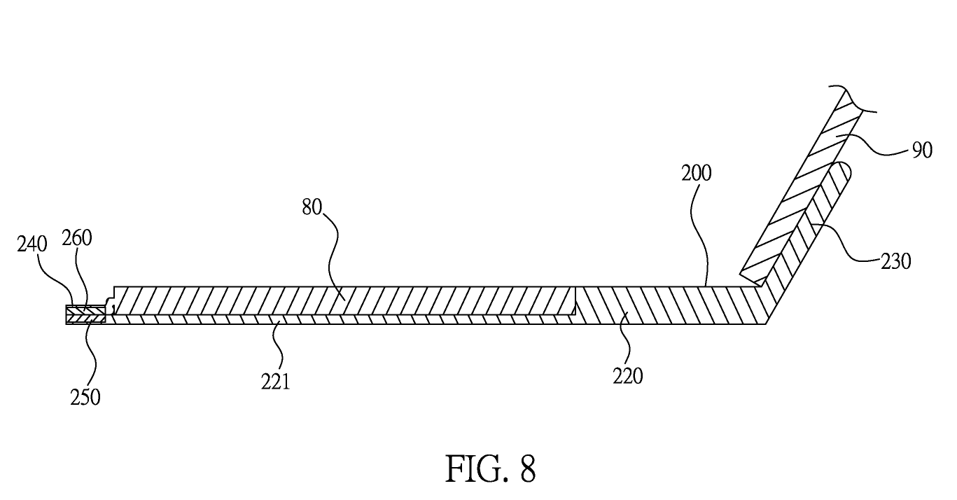

Referring to FIG. 7 and FIG. 8, wherein FIG. 7 is an exploded view illustrating the detachable rotary extended keyboard plate according to one another preferred embodiment of the present invention; and FIG. 8 is a cross sectional view illustrating the assembly of the detachable rotary extended keyboard plate according to one another preferred embodiment of the present invention.

As shown in figures, according to the detachable rotary extended keyboard plate disclosed in one another preferred embodiment of the present invention, the detachable rotary extended keyboard plate includes a sleeve member 200. The sleeve member 200 includes a bottom plate 220, a support sheet 230, a combination sheet 240, at least a first fasten device 250 and at least a second fasten device 260.

The sleeve member 200 is e.g. but not limited to be made of leather, foamed sponge or polyurethane, according to this embodiment, polyurethane is adopted for being integrally formed as the sleeve member 200.

One end of the bottom plate 220 is formed with an engaging sheet 221 allowing a keyboard 80 to be disposed thereon, wherein the thickness defined by the engaging sheet 221 and the keyboard 80 is approximately the same as the thickness of the bottom plate 220, thereby preventing the keyboard 80 from protruding higher than the bottom plate 220 after being assembled. Wherein, the bottom plate 220 is e.g. but not limited to a thick paper board, a plastic plate or a glass fiber/carbon fiber plate; the keyboard 80 is e.g. but not limited to a wired keyboard or a wireless keyboard.

The support sheet 230 is formed at one side of the bottom plate 220, e.g. but not limited to the right side, and is combined with a portable electronic device 90 or a protective case of the portable electronic device 90, thereby enabling the portable electronic device 90 to stand on the bottom plate 220. Wherein, the portable electronic device 90 is e.g. but not limited to a tablet computer.

One end of the combination sheet 240 is combined with the keyboard 80. Wherein, the material of the combination sheet 240 is e.g. but not limited to a flexible material, and the combination sheet 240 is dispose at a bottom side at another end of the keyboard 80. Wherein, the housing of the keyboard 80 is e.g. but not limited to be covered with the flexible material which is the same as the combination sheet 240, thereby allowing the combination sheet 240 to be integrated formed with the housing of the keyboard 80, or a slit (not shown in figures) is formed between the upper portion and the lower portion of the housing of the keyboard 80 for allowing the combination sheet 240 to be clamped therein, so the keyboard 80 is enabled to be combined with the combination sheet 240. According to this embodiment, one end of the combination sheet 240 is clamped in the housing of the keyboard 80, however the above-mentioned arrangement is served as an example for fully disclosing the present invention and shall not be the limitation to the scope of the present invention.

The at least one first fasten device 250 is disposed on the engaging sheet 221. According to this embodiment, the quantity of the at least one first fasten device 250 is two, and the two first fasten devices 250 are respectively disposed at the right side and the left side of the engaging sheet 221, however the above-mentioned arrangement is served as an example for fully disclosing the present invention and shall not be the limitation to the scope of the present invention. Wherein, the first fasten device 250 is e.g. but not limited to a Velcro fastener, a buckle member, a magnetic member or a tenon; according to the present invention, a magnetic member is adopted for illustration and shall not be the limitation to the scope of the present invention.

The at least one second fasten device 260 is disposed on the combination sheet 240 and corresponding to the location where the first fasten device 250 is disposed, the second fasten device 260 is able to be combined with the first fasten device 250, thereby enabling the keyboard 80 to be fastened on the bottom plate 220. According to this embodiment, the quantity of the at least one second fasten device 260 is two, and the two second fasten devices 260 are respectively disposed at one side of the keyboard 80 and on the combination sheet 240, however the above-mentioned arrangement is served as an example for fully disclosing the present invention and shall not be the limitation to the scope of the present invention. Wherein, the second fasten device 260 is e.g. but not limited to a Velcro fastener, a buckle member, a magnetic member or a tenon.

As shown in FIG. 8, when being assembled, the second fasten devices 60 are bent by the user for being combined with the first fasten devices 50, so the keyboard 80 is fastened on the engaging sheet 221 with the keyboard 80 facing downwardly, then the support sheet 230 is combined with the portable electronic device 90 or a protective case of the portable electronic device 90, wherein the above two can be combined through a Velcro fastener, magnetic members or a tenon, so the bottom of the portable electronic device 90 is enabled to stand and be fastened on the bottom plate 220, what shall be addressed is that the combining manner is not the main characteristic of the present invention, therefore no further illustration is provided.

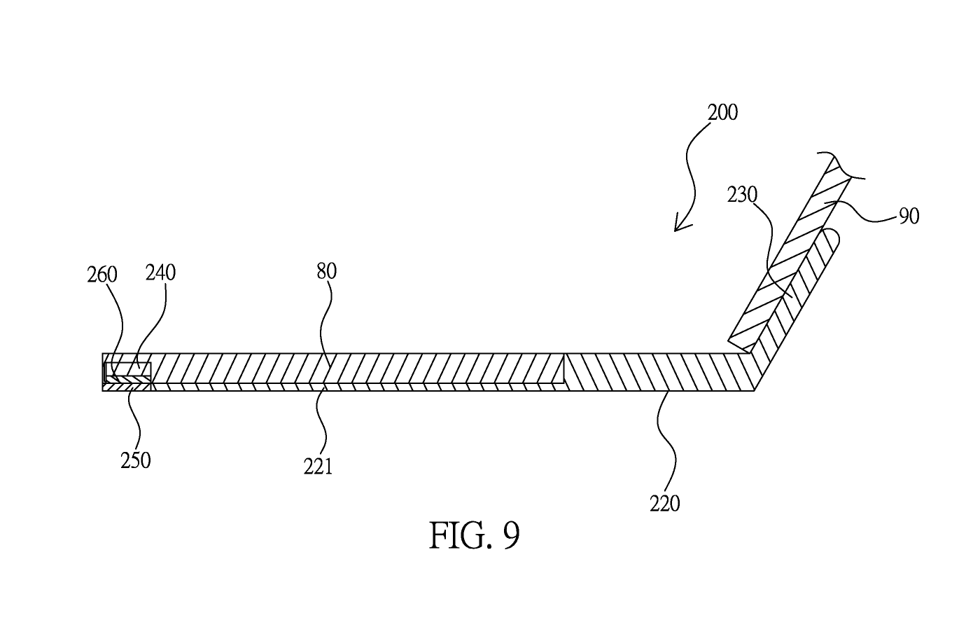

Referring to FIG. 9, which is a schematic view illustrating the combination sheet being able to be fastened on the keyboard according to one another preferred embodiment of the present invention. As shown in FIG. 9, according to the detachable rotary extended keyboard plate disclosed in one another preferred embodiment of the present invention, the combination sheet 240 is made of a flexible material and combined with the housing of the keyboard 80, and the bent portion of the combination sheet 240 is relatively thinner thereby being easily to be bent, and the second fasten devices 260 are disposed at the end portion thereof; when being rotated, the keyboard 80 drives the flexible combination sheet 240 to be outwardly rotated, and the keys of the keyboard 80 are allowed to face upwardly, the first fasten devices 250 and the second fasten devices 260 are utilized for fastening the keyboard 80 on the bottom plate 220, thereby allowing the user to control the portable electronic device 90 or input texts or numbers to the portable electronic device 90 through the keyboard 80.

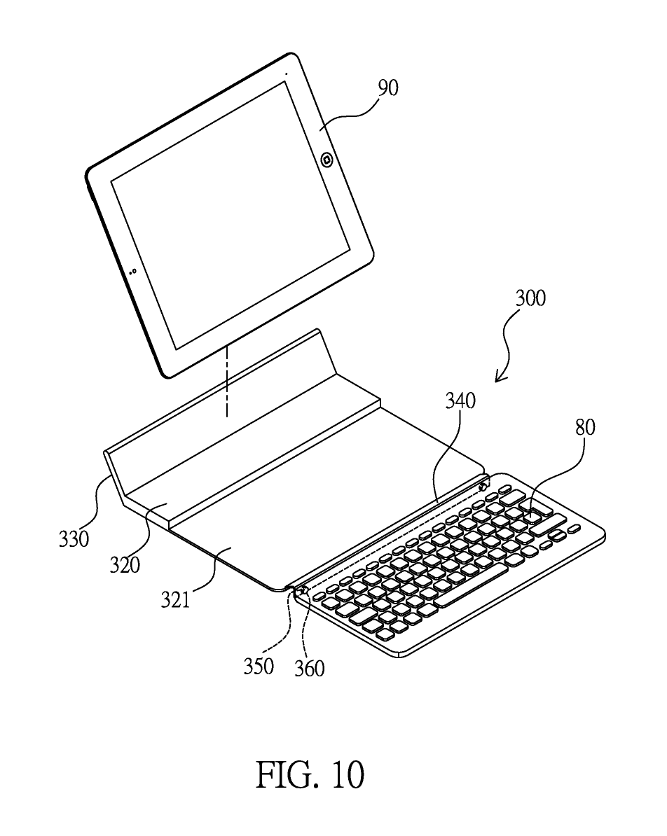

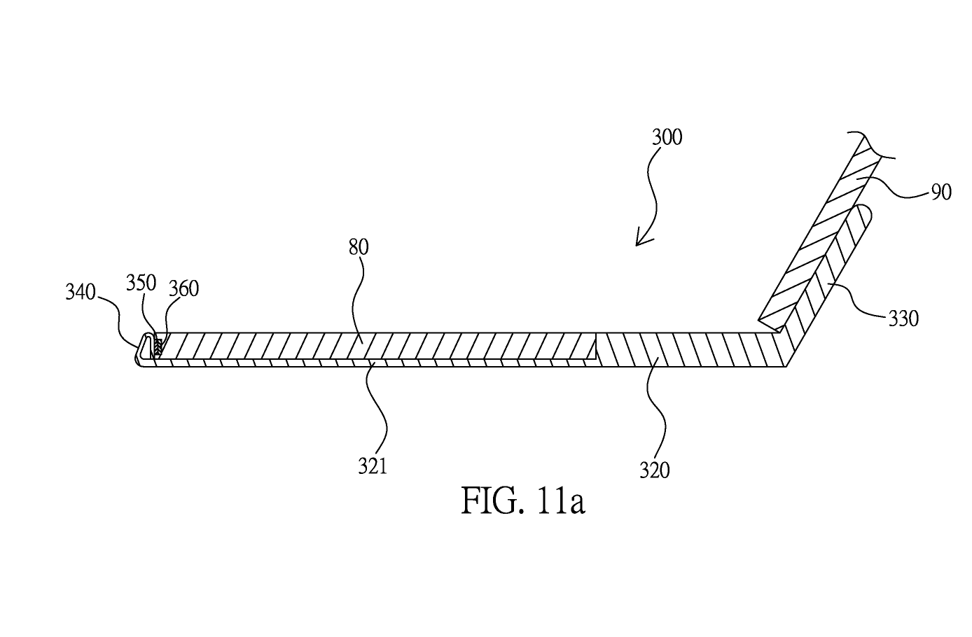

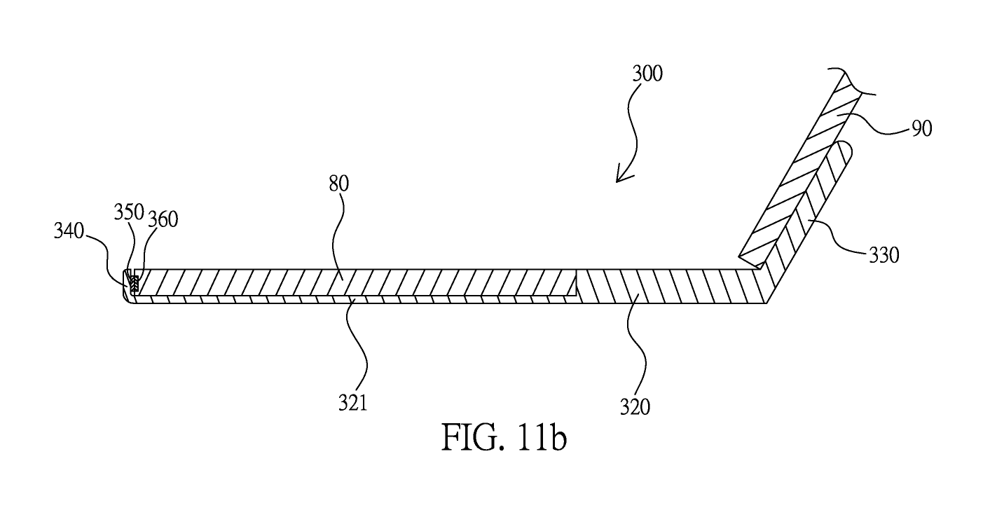

Referring to FIG. 10 and FIG. 11b, wherein FIG. 10 is an exploded view illustrating the detachable rotary extended keyboard plate according to still one another preferred embodiment of the present invention; FIG. 11a is a cross sectional view illustrating the assembly of the detachable rotary extended keyboard plate wherein one distal end of the combination sheet being formed with a bending according to still one another preferred embodiment of the present invention; and FIG. 11b is a cross sectional view illustrating the assembly of the detachable rotary extended keyboard plate wherein one distal end of the combination sheet not being formed with a bending according to still one another preferred embodiment of the present invention.

As shown in figures, according to the detachable rotary extended keyboard plate disclosed in still one another preferred embodiment of the present invention, the detachable rotary extended keyboard plate includes a sleeve member 300. The sleeve member 300 includes a bottom plate 320, a support sheet 330, a combination sheet 340, a first fasten device 350 and a second fasten device 360.

The sleeve member 300 is e.g. but not limited to be made of leather, foamed sponge or polyurethane, according to this embodiment, polyurethane: is adopted for being integrally formed as the sleeve member 300.

One end of the bottom plate 320 is formed with an engaging sheet 321 allowing a keyboard 80 to be disposed thereon, wherein the thickness defined by the engaging sheet 321 and the keyboard 80 is approximately the same as the thickness of the bottom plate 320, thereby preventing the keyboard 80 from protruding higher than the bottom plate 320 after being assembled. Wherein, the bottom plate 320 is e.g. but not limited to a thick paper board, a plastic plate or a glass fiber/carbon fiber plate; the keyboard 80 is e.g. but not limited to a wired keyboard or a wireless keyboard.

The support sheet 330 is formed at one side of the bottom plate 320, e.g. but not limited to the right side, and is combined with a portable electronic device 90 or a protective case of the portable electronic device 90, thereby enabling the portable electronic device 90 to stand on the bottom plate 320. Wherein, the portable electronic device 90 is e.g. but not limited to a tablet computer.

The combination sheet 340 is formed at one side of the engaging sheet 321 but not limited to be integrally extended from the engaging sheet 321, the combination sheet 340 can also be fastened at one side of the engaging sheet 321 with an adhering manner, e.g. but not limited to the outer side. Wherein, the material of the combination sheet 340 is e.g. but not limited to a flexible material. Wherein, one distal end of the combination sheet 340 can be formed with a bending (as shown in FIG. 11a) or not formed with a bending (as shown in FIG. 11b).

The first fasten device 350 is disposed on the combination sheet 340, wherein the first fasten device 350 is e.g. but not limited to a magnet or a Velcro fastener.

The second fasten device 360 is disposed on the keyboard 80 and corresponding to the location where the first fasten device 350 is disposed, the second fasten device 360 is able to be combined with the first fasten device 350, thereby enabling the keyboard 80 to be fastened on the bottom plate 320. The second fasten device 360 is able to be combined with the first fasten device 350, and the second fasten device 360 is e.g. but not limited to a magnet or a Velcro fastener.

In addition, the first fasten device 350 and the second fasten device 360 are formed in a block-like structure and respectively disposed at two sides of the combination sheet 340 and the keyboard 80, or formed in a strip-like structure and respectively disposed at the center of the combination sheet 340 and the keyboard 80. According to this embodiment, the first fasten device 350 and the second fasten device 360 are e.g. but not limited to formed in a block-like structure and respectively disposed at two sides of the combination sheet 340 and the keyboard 80, however the above-mentioned arrangement is served as an example for fully disclosing the present invention and shall not be the limitation to the scope of the present invention.

As shown in FIG. 11a, the distal end of the combination sheet 340 is bent for allowing the first fasten device 350 and the second fasten device 360 to be combined; or as shown in FIG. 11b, the distal end of the combination sheet 340 is not bent but the first fasten device 350 and the second fasten device 360 are still enabled to be combined. When being assembled, the first fasten device 350 is bent by the user for enabling the first fasten device 350 to be combined with the second fasten device 360, so the keyboard 80 is fastened on the engaging sheet 321 with the keyboard 80 facing downwardly, then the support sheet 330 is combined with the portable electronic device 90 or a protective case of the portable electronic device 90, wherein the above two can be combined through a Velcro fastener, magnetic members or a tenon, so the bottom of the portable electronic device 90 is enabled to stand and be fastened on the bottom plate 320, what shall be addressed is that the combining manner is not the main characteristic of the present invention, therefore no further illustration is provided.

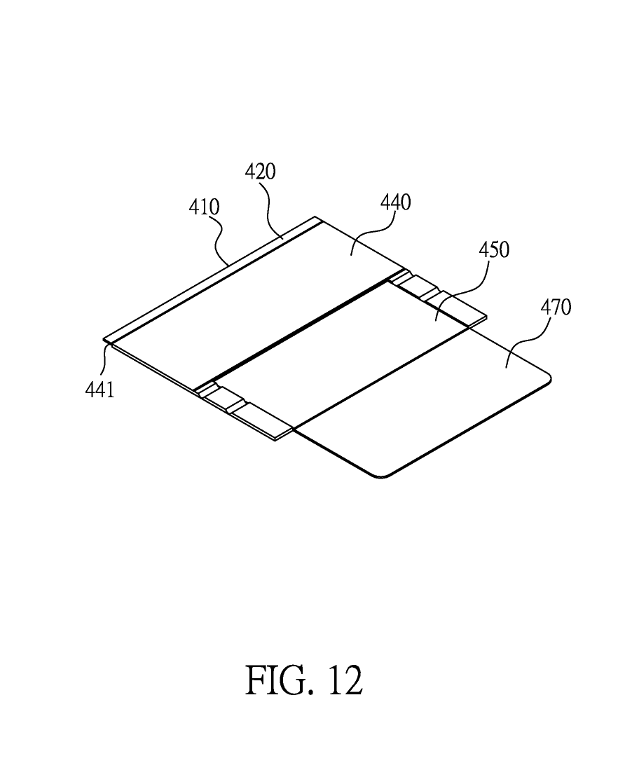

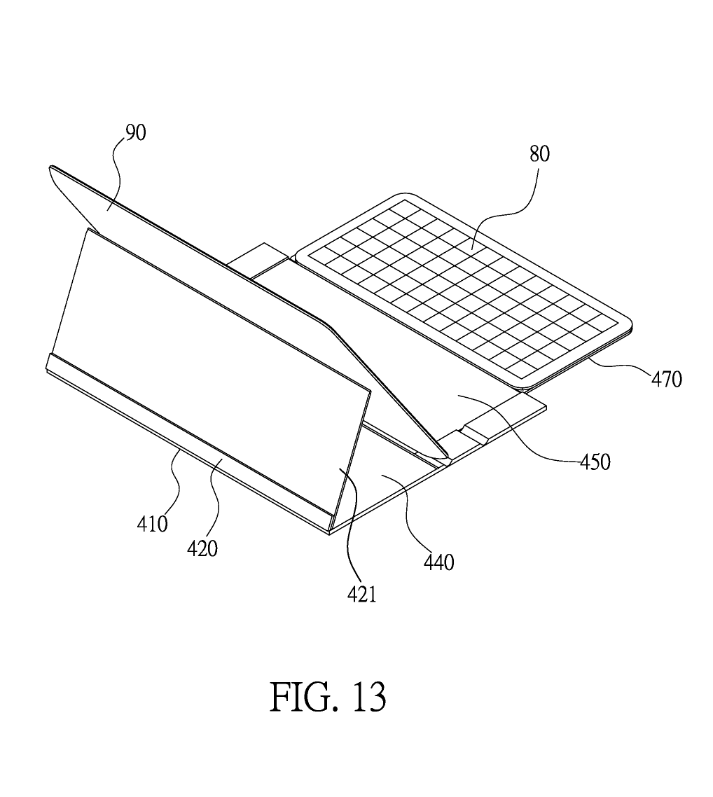

Referring to FIG. 12 and FIG. 13, wherein FIG. 12 is an exploded view illustrating the detachable rotary extended keyboard plate according to still one another preferred embodiment of the present invention; and FIG. 13 is a schematic view illustrating the assembly of the detachable rotary extended keyboard plate and a portable electronic device according to still one another preferred embodiment of the present invention.

As shown in figures, according to the detachable rotary extended keyboard plate disclosed in still one another preferred embodiment of the present invention, the detachable rotary extended keyboard plate includes a sleeve member 410. The sleeve member 410 includes a support sheet 420, a first fasten sheet 440, a second fasten sheet 450 and a front sheet 470.

The sleeve member 410 is e.g. but not limited to be made of leather, foamed sponge or polyurethane, according to this embodiment, polyurethane is adopted for being integrally formed as the sleeve member 410.

The support sheet 420 is formed at one end of the sleeve member 410, and is e.g. but not limited to a Velcro fastener or magnetic members; according to the present invention, magnetic members is adopted for illustration and shall not be the limitation to the scope of the present invention. With the magnetic property provided to the support sheet 420, the support sheet 420 is able to be attracted and fastened on a rack unit (not shown in figures) of a metal housing of the portable electronic device 90 or be attracted and fastened on a rack unit of a protecting sleeve of the portable electronic device 90.

The first fasten sheet 440 is formed at one side of the support sheet 420, and a bending slot 441 is formed between the first fasten sheet 440 and the support sheet 420. Wherein, the bending slot 441 is e.g. but not limited to be formed through a high frequency pressing operation.

The second fasten sheet 450 is formed at one side of the first fasten sheet 440 or is integrally formed the first fasten sheet 450. Thus, through disposing the bottom of the portable electronic device 90 on the second fasten sheet 450, the portable electronic device 90 is supported for standing and the angle of the portable electronic device 90 is also able to be adjusted.

The front sheet 470 is formed at one side of the second fasten sheet 450 and allows a keyboard 80 to be disposed thereon, wherein the connecting means for the front sheet 470 and the second fasten sheet 450 can be any means disclosed in the above-mentioned embodiments illustrating the detachable rotary extended keyboard plate provided by the present invention. Wherein, the keyboard 80 is e.g. but not limited to a wired keyboard or a wireless keyboard, when a wired keyboard is adopted, the wired keyboard can be connected to the portable electronic device 90 with a wire embedding manner, when a wireless keyboard is adopted, the wireless keyboard can be connected to the portable electronic device 90 through Bluetooth or other wireless communicating manners, thereby allowing the user to control the portable electronic device 90 or input texts or numbers to the portable electronic device 90. In addition, the support sheet 420 is further formed with a rack unit 421, the rack unit 421 can be formed in the housing of the portable electronic device 90 or formed on a sleeve member of the protecting sleeve of the portable electronic device 90, thereby enabling the portable electronic device 90 to stand. Moreover, the bottom of the rack unit 421 is further provided with at least a magnetic member or a Velcro fastener (both not shown in figures) thereby being connected to the support sheet 420. The support sheet 420 is formed at one end of the sleeve member 410, and is e.g. but not limited to a magnetic member or a Velcro fastener; according to the present invention, a magnetic member is adopted for illustration and shall not be the limitation to the scope of the present invention. Through the magnetic support sheet 420 being able to be attracted on the rack unit 421, the two components can be assembled or disassembled according to the user's desire.

According to the detachable rotary extended keyboard plate provided by the present invention, the engaging sheet is provided for allowing a keyboard to be disposed thereon, and the keyboard is able to be rotated for being disposed on or released from the engaging sheet, so advantages of storing the keyboard and adjusting the operation distance of the keyboard are provided. As such, the detachable rotary extended keyboard plate provided by the present invention is able to efficiently improve the disadvantages of the conventional protecting sleeve of the portable device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A detachable rotary extended keyboard plate, including a sleeve member, said sleeve member including:
a bottom plate, having one end formed with an engaging sheet allowing a keyboard to be disposed thereon;
a support sheet, formed at one side of said bottom plate and combined with a portable electronic device or a protective case of the portable electronic device, thereby enabling said portable electronic device to stand on said bottom plate;
a combination sheet, formed through being inwardly bent at another side of said bottom plate;
at least a first fasten device, disposed on said engaging sheet or said combination sheet; and
at least a second fasten device disposed on said keyboard and corresponding to the location where said first fasten device being disposed, said second fasten device being able to be combined with said first fasten device for enabling said keyboard to be fastened on said engaging sheet.

2. The detachable rotary extended keyboard plate according to claim 1, wherein said first fasten device and said second fasten device are a Velcro fastener, a buckle member, a magnetic member or a tenon.

3. The detachable rotary extended keyboard plate according to claim 1, wherein said portable electronic device is a tablet computer, said keyboard is a wired or wireless keyboard.

4. The detachable rotary extended keyboard plate according to claim 1, wherein said combination sheet is made of a flexible material, and disposed at a bottom side at another end of said keyboard or covered another end of said keyboard.

5. A detachable rotary extended keyboard plate, including a sleeve member, said sleeve member including:
a bottom plate, formed with an engaging sheet allowing a keyboard to be disposed thereon;
a support sheet, formed at one side of said bottom plate and combined with a portable electronic device or a protective case of the portable electronic device, thereby enabling said portable electronic device to stand on said bottom plate;
a combination sheet, having one end combined with said keyboard;
at least a first fasten device, disposed on said engaging sheet; and
at least a second fasten device, disposed on said combination sheet and corresponding to the location where said first fasten device being disposed, said second fasten device being able to be combined with said first fasten device for enabling said keyboard to be fastened on said bottom plate.

6. The detachable rotary extended keyboard plate according to claim 5, wherein said first fasten device and said second fasten device are a Velcro fastener, a buckle member, a magnetic member or a tenon.

7. The detachable rotary extended keyboard plate according to claim 5, wherein said portable electronic device is a tablet computer, said keyboard is a wired or wireless keyboard.

8. The detachable rotary extended keyboard plate according to claim 5, wherein said combination sheet is made of a flexible material, and combined with a housing of said keyboard or fastened on top of said keyboard through a Velcro fastener or magnetic members.

9. A detachable rotary extended keyboard plate, including a sleeve member, said sleeve member including:
a bottom plate, formed with an engaging sheet allowing a keyboard to be disposed thereon;
a support sheet, formed at one side of said bottom plate and combined with a portable electronic device or a protective case of the portable electronic device, thereby enabling said portable electronic device to stand on said bottom plate;
a combination sheet, formed at one side of said engaging sheet, having one end formed with a bending part for being bent so as to be combined with said keyboard;
a first fasten device, disposed on said engaging sheet; and
a second fasten device, disposed on said keyboard and corresponding to the location where said first fasten device being disposed, said second fasten device being able to be combined with said first fasten device for enabling said keyboard to be fastened on said bottom plate.

10. The detachable rotary extended keyboard plate according to claim 9, wherein said first fasten device and said second fasten device are a magnet or a Velcro fastener.

11. The detachable rotary extended keyboard plate according to claim 9, wherein said portable electronic device is a tablet computer, said keyboard is a wired or wireless keyboard.

12. The detachable rotary extended keyboard plate according to claim 9, wherein said first fasten device and said second fasten device are formed in a block-like structure and respectively disposed at two sides of said combination sheet and said keyboard, or formed in a strip-like structure and respectively disposed at the center of said combination sheet and said keyboard.

13. A detachable rotary extended keyboard plate, including a sleeve member, said sleeve member including:
a support sheet;
a first fasten sheet, formed at one side of said support sheet, and a bending slot being formed between said first fasten sheet and said support sheet;
a second fasten sheet, formed at one side of said first fasten sheet or being integrally formed said first fasten sheet, and
a front sheet, formed at one side of said second fasten sheet, allowing a keyboard to be disposed thereon;
wherein through disposing the bottom of said portable electronic device on said second fasten sheet, said portable electronic device is able to be supported for standing and the angle of said portable electronic device is also able to be adjusted.

14. The detachable rotary extended keyboard plate according to claim 13, wherein said sleeve member is a leather, foamed sponge or polyurethane sleeve member, said support sheet is a Velcro fastener or magnetic members.

15. The detachable rotary extended keyboard plate according to claim 13, wherein said keyboard is a wired or wireless keyboard capable of being connected to said portable electronic device with a wired or wireless communicating manner.

16. The detachable rotary extended keyboard plate according to claim 13, wherein said support sheet is further formed with a rack unit, said rack unit is able to be formed in a housing of said portable electronic device or formed on a sleeve member of a protecting sleeve of said portable electronic device, thereby enabling said portable electronic device to stand.
